(19) United States
(12) Patent Application Publication
(10) Pub. No.: US 2026/0256117 A1
(43) Pub. Date: Sep. 3, 2026

(54) SYSTEM FOR PERSONALISED PET CARE RECOMMENDATIONS AND METHOD THEREOF

(71) Applicant: FitPet LLC, Austin, TX (US)

(72) Inventor: Vanissa Jenifer Colaco, Austin, TX (US)

(21) Appl. No.: 19/553,650

(22) Filed: Mar. 2, 2026

Related U.S. Application Data
(60) Provisional application No. 63/766,184, filed on Mar. 3, 2025.

(51) Int. Cl. A01K 29/00

(52) U.S. Cl. CPC A01K 29/004

(57) ABSTRACT

The present invention relates to a system for personalised pet care recommendations. The system comprises a hierarchical data repository module configured to store hierarchical historical reference data associated with pets, a user input interface module for collecting pet-specific data through web-based or mobile-based applications, and a hardware integration module configured to acquire sensor-driven pet data. Further, a data processing and insight generation module processes the collected data to generate personalised pet care recommendations, which are disseminated, upon authorisation by a data publishing and access control module, through a dashboard and/or third-party integration modules. The invention further relates to a method for personalised pet care recommendations, maintaining controlled data access.

### CROSS-REFERENCE TO RELATED APPLICATIONS

This application claims priority from the provisional application numbered 63/766,184 filed with United States Patent Office, on 3 Mar. 2025 entitled “A SYSTEM FOR PERSONALISED PET CARE RECOMMENDATIONS AND METHOD THEREOF”, the entirety of which is expressly incorporated herein by reference.

### BACKGROUND OF THE INVENTION

### Technical Field of the Invention

The present invention relates to the field of a personalised pet care recommendations system. More particularly, the invention relates to a personalised pet care recommendations system powered using an artificial intelligence that integrates hierarchical data modeling, real-time user input, and third-party services to enhance pet health and well-being. The invention further discloses a method for generating personalized pet care recommendations by simultaneously analysing anatomical, behavioural, and sensor-driven data.

### Background of the Invention

With the rising trend in pet ownership, there is an increasing demand for effective and personalized pet care solutions. However, existing systems remain fragmented, requiring pet owners to rely on a combination of online research, veterinary consultations, and generalized pet care applications. Such conventional approaches are often inefficient, inconsistent, and insufficiently tailored to accommodate an individual pet's unique characteristics, such as behavioural patterns, medical history, and anatomical traits.

Despite advancements in technology, existing pet care solutions do not adequately provide a unified framework capable of analysing and predicting behaviour of an individual pet, health patterns, and care requirements in an integrated manner. Many pet-related mobile applications focus on singular aspects, such as activity tracking, diet management, or appointment scheduling, without offering a comprehensive, data-driven approach. Furthermore, such solutions often rely heavily on manual user input, lack integration with heterogeneous data sources, and do not consistently provide predictive or proactive insights. As a result, pet owners face challenges in obtaining reliable recommendations that may enhance pet well-being and help mitigate preventable health issues.

For instance, Patent Application No. EP3264299A1, entitled “System and method for pet monitoring,” discloses a system and method enabling pet owners, veterinarians, or caretakers to remotely monitor pet health. The disclosed system utilizes a feeding device and a portable device worn by the pet to monitor activity levels and dietary intake, with collected data processed by a cloud device. While the disclosure provides mechanisms for monitoring and analysis of certain pet-related parameters, it does not sufficiently describe a framework for simultaneously interpreting user-provided inputs, historical data, and behavioural data to generate comprehensive, actionable pet care insights.

Patent Application No. U.S. Pat. No. 10,264,765B2, entitled “Pet monitoring and recommendation system,” discloses a pet monitoring system comprising a pet activity server and a pet database defining preliminary schedules for pets. Owners may customize pet device configurations based on such schedules, and devices may interact with one another. Although the system addresses aspects of monitoring and personalization, the disclosure does not emphasize hierarchical data modeling, integration of third-party services, or coordinated interpretation of diverse data sources to deliver individualized pet care recommendations.

Patent Application No. KR102085289B1, entitled “Method and System for Managing Pet Health,” discloses a method and apparatus for managing pet health conditions using wearable devices to monitor physiological parameters in real time. While the disclosure focuses on emergency detection and symptom-based response, it does not detail mechanisms for generating structured intelligence summaries, hierarchical data interpretation, or application programming interface (API)-based integration with external services.

Patent Application No. CN104932459B, entitled “A Kind of Multifunctional Pet Management Monitoring System Based on Internet of Things,” discloses a monitoring system employing wearable devices, mobile terminals, data processors, and databases to collect and transmit real-time pet information. The disclosed system primarily emphasizes sensor-driven data acquisition and transmission and does not focus on persistent intelligence modeling or contextual interpretation across historical interaction data.

Patent Application No. CN109144975A, entitled “A Kind of Domestic Pets Comprehensive Management Householder Method and System,” discloses a system comprising wearable physiological data collection modules, environmental data acquisition modules, data processing modules, and service modules. While the system provides mechanisms for health prediction and feedback, it does not emphasize incorporation of individualized anatomical, behavioural, and historical characteristics into a unified pet intelligence profile for customized recommendation generation.

Collectively, the existing prior art describes various pet care systems that monitor environmental conditions, collect sensor-driven data, or track observable behaviours of the pets, often in isolation or within limited functional scopes.

Accordingly, despite advancements in technology-driven pet care systems, gaps persist in the field. There remains a need for a comprehensive, data-driven yet human-centred approach in which historical, anatomical, and behavioural data are jointly interpreted to provide personalized, proactive pet care recommendations.

### SUMMARY OF THE INVENTION

The present invention addresses the limitations of the prior art by disclosing a system for personalised pet care recommendations and a method thereof, configured to generate, manage, and selectively disseminate pet-related intelligence along with recommendations. The disclosed invention addresses challenges associated with the fragmented pet data management, transient conversational systems, opaque inference mechanisms, and uncontrolled data exposure by providing a unified framework that persistently maintains pet profile states, interaction evidence, inferred attributes, and behavioural insights of the pets over time and offers recommendations.

In one aspect, the invention discloses a system comprising a centralized data repository that stores derived structured pet intelligence, comprising versioned pet profile states, inferred attributes, behavioural insights, associated confidence values and temporal validity parameters, while maintaining raw pet interaction events as immutable evidentiary records. The system further comprises a data processing and insight generation module configured to normalize incoming pet-related data, resolve conflicts between incoming pet-related data and existing pet profile states using a weighted arbitration logic, derive inferred pet attributes and behavioural insights based on the validated evidence and population-level priors, and generate behavioural insights of the pets through longitudinal analysis, without overwriting historical data, thereby supporting personalized pet care recommendations tailored to each individual pet profile. Resolving conflicts using weighted arbitration logic comprises evaluating incoming pet-related data using a plurality of weighting factors including at least source reliability, temporal recency, and confidence thresholds wherein the source reliability is a function of a plurality of data sources classified as sensor-derived, user-entered, or third-party sourced.

The system further comprises a data publishing and access control module connected to one or more external interfaces and configured to control dissemination of pet intelligence and recommendations through permissioned logical projections. The data publishing and access control module enforces authorization policies, permission levels, and domain-specific constraints to generate logical projections of pet intelligence for different consumption domains, such that consumer-facing, business-facing, and non-profit-facing interfaces receive only contextualized and authorized logical projections of pet intelligence followed by recommendations, while the underlying centralized data repository remains protected as a single source of truth.

In another aspect, the invention discloses a method for personalised pet care recommendations, the method comprising collecting pet-related data including anatomical data, behavioural data, and sensor-driven data associated with an individual pet. The anatomical data comprises historical and species-related information, including but not limited to breed characteristics, medical history, and genetic predispositions. The behavioural data comprises user-provided inputs relating to observed behaviour, activity patterns, feeding habits, and lifestyle characteristics of the pet, while the sensor-driven data is obtained from wearable devices or monitoring systems configured to capture physiological and activity-related parameters of the pet over time. The method further comprises processing the collected anatomical, behavioural, and sensor-driven data using data processing techniques, including artificial intelligence and machine learning models, to analyse correlations, identify patterns, detect anomalies, and generate inferred insights relating to pet health, behaviour, and wellness. Based on the processed data, the method further comprises generating and sending predictive alerts and personalised recommendations tailored to an individual pet profile, thereby enabling proactive pet care and informed decision-making by pet owners and associated service providers.

The disclosed system and method preserve evidentiary integrity and explainability by maintaining a clear separation between raw interaction events and derived structured pet intelligence, thereby enabling post-hoc auditability, confidence decay, and longitudinal refinement of inferred attributes. The invention further reduces computational overhead and improves consistency of generated outputs by relying on compact, structured contextual representations rather than full conversational replay or unbounded data retrieval.

The system for personalized pet care recommendations and the method thereof, as disclosed herein, are extensible and adaptable to evolving data sources, inference techniques, and integration protocols, and are not limited to any specific artificial intelligence model, deployment environment, or interaction modality. Accordingly, the invention provides a robust, scalable, and privacy-aware foundation for delivering personalized pet care recommendations and supporting multi-domain utilization, while remaining open-ended and future-proof.

### BRIEF DESCRIPTION OF THE FIGURES

The foregoing and other features of embodiments will become more apparent from the following detailed description of embodiments when read in conjunction with the accompanying drawings. In the drawings, like reference numerals refer to like elements.

FIG. 1 illustrates a block diagram of a system for personalized pet care recommendations, in accordance with one or more embodiments of the present invention.

FIG. 2 illustrates a flowchart of a method for personalized pet care recommendations in accordance with one or more embodiments of the present invention.

FIG. 3 illustrates a block diagram of an exemplary logical decomposition of a data processing and insight generation module of the system for personalised pet care recommendations depicted in FIG. 1, together with associated cooperation with a central database and a data publishing and access control module, in accordance with one or more embodiments of the invention.

FIG. 4 illustrates a method of an exemplary operational workflow for data processing and insight generation performed by the system (100) for personalised pet care recommendations.

### DETAILED DESCRIPTION OF THE INVENTION

The preferred embodiments are provided so that the disclosure will be thorough and will fully convey the scope to those who are skilled in the art. Various specific details are set as specific components to provide an overall understanding of the preferred embodiments of the present disclosure. It will be apparent to those skilled in the art that the specific details need not be employed, and the embodiments may be embodied in many different forms and the steps followed do not limit the scope of the disclosure. It is also to be understood that the terminology used herein is for the purpose of describing only the particular embodiments of the invention and is not intended to limit the scope of the invention in any manner. It must also be noted that as used herein and in the appended claims, the singular forms “a,” “an,” and “the” include plural references unless the context clearly dictates otherwise.

In order to describe and point out the subject matter of the claimed invention, the following definitions are provided for specific terms, which are used in the following written description more clearly and concisely.

The term “Pet intelligence” refers to a structured and machine-interpretable representation of pet-related information comprising historical data, interaction events, inferred attributes, behavioural insights, and contextual summaries associated with an individual pet.

The term “Interaction event” refers to a discrete, time-stamped record representing an observed, reported, or sensor-detected activity, condition, or occurrence related to a pet, preserved as immutable evidentiary data.

The term “Pet profile state” refers to a versioned, time-indexed representation of an individual pet's structured attributes, including inferred attributes associated with confidence values, maintained independently of conversational or session-based interactions.

The term “Derived pet intelligence” refers to data generated by processing interaction events and pet profile states to produce inferred attributes, behavioural insights along with associated confidence score and metadata values.

The term “Logical projection” refers to a permission-controlled, domain-specific representation of derived pet intelligence generated without exposing or duplicating the underlying stored data.

The term “Longitudinal evaluation” refers to an analysis process that considers temporally ordered interaction events and historical pet profile states to generate or refine inferences over time.

The term “Population-level prior” refers to a precomputed baseline probability distribution associated with the pets sharing common characteristics such as species, breed, age range, sex, or lifestyle class.

The term “Risk marker” refers to a probabilistic signal derived from the longitudinal interaction events indicating an elevated likelihood of an adverse condition or undesirable outcome.

The term “Reliability weight” refers to a weighting factor applied to the attribute values derived from pet-related interaction events during application of weighted arbitration logic to comparatively evaluate multiple attribute values and determine a selected attribute value for inclusion in a versioned pet profile state. The reliability weight evaluation criteria may include, but are not limited to, the method of data capture, susceptibility to subjective estimation, sampling frequency, and consistency with historical measurements.

The term “Confidence value” refers to a quantitative measure associated with an inferred pet attribute after inference generation and arbitration, representing the level of evidentiary support for the inferred pet attribute.

The term “Candidate interface output” refers to a generated recommendation, alert, narrative, or projection produced by the data processing and insight generation module prior to selective dissemination to a dashboard or third-party integration interface.

The term “Weighted arbitration logic” refers to a deterministic evaluation methodology executed by the data processing and insight generation module to resolve conflicts between multiple pet-related data inputs or attribute values by assigning reliability weights and temporal weighting factors based on predefined criteria including source reliability, temporal recency, and confidence thresholds, and producing an updated attribute determination for inclusion in a versioned pet profile state while preserving underlying immutable interaction event records.

The term “Reasoning component” refers to a functional layer within the data processing and insight generation module implemented using the LLM module and configured to operate on assembled contextual data generated by the context assembly module to produce interpretive narratives, explanatory annotations, or personalized pet care recommendations.

The “Aggregated pet intelligence” refers to a composite representation of structured pet intelligence derived from a plurality of pets or interaction events, compiled for domain-specific analysis or projection.

The present invention relates to a system for personalised pet care recommendations that collects anatomical, behavioural, and sensor-driven pet data from multiple sources, process the collected pet-related data to generate inferred pet attributes and behavioural insights of the pet, and selectively disseminate authorised and contextualised recommendations to different consumption domains while preserving evidentiary integrity and data governance.

The present invention further relates to a method for personalised pet care recommendations, the method comprising collecting anatomical, behavioural, and sensor-driven pet data, processing the collected data to derive insights and predictions, and generating personalised recommendations and alerts tailored to an individual pet profile through a governed and longitudinal evaluation process.

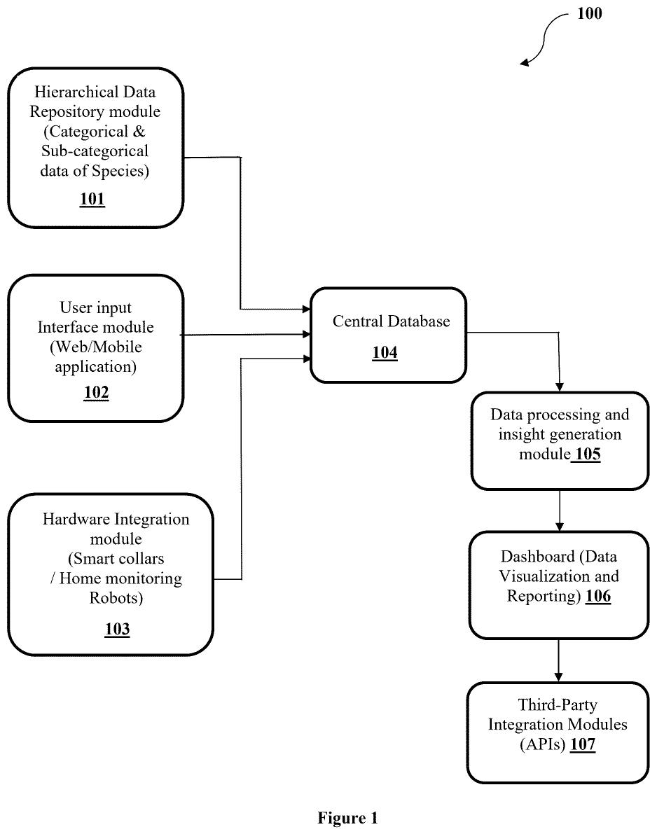

FIG. 1 illustrates a block diagram of a system (100) for personalised pet care recommendations in accordance with one embodiment of the present invention. The system (100) for personalised pet care recommendations, hereinafter referred to as the system (100), is realized through a hardware-implemented and hardware-assisted architecture comprising a plurality of interoperating modules configured to collect, process, and analyse pet-related data and to generate personalised recommendations.

The system (100) comprises a hierarchical data repository module (101) configured to organize and store historical pet-related data categorically, including species-level and sub-species-level information. The hierarchical data repository module (101) configured to provide population-level priors based on species, breed, and/or age characteristics of plurality of pets to initialize or bias the inference generation. The hierarchical data repository module (101) further comprises sub-categorical attribute models defining characteristics of the pets such as size, age, breed, and species-specific behavioural traits. The system (100) further comprises a user input interface module (102) configured to collect pet-related inputs, including walking routines, feeding habits, observed behaviours, and preferences. In an embodiment, the user input interface module (102) is implemented as a web-based application. In another embodiment, the user input interface module (102) is implemented as a mobile-based application.

In an embodiment, the user input data provided by the pet owners is linked to a central database (104) and then fed into a data processing and insight generation module (105), which may employ artificial intelligence techniques and is integrated with hierarchical data repository module (101). Further, the data processing and insight generation module (105) processes the received data to generate structured pet intelligence, including metadata summaries personalised for pet owners and service providers along with personalized pet care recommendations. The hierarchical data received from the hierarchical data repository module (101) enables the data processing and insight generation module (105) to access and analyse species-specific historical data, thereby providing a baseline for generating accurate recommendations. Further, the pet care recommendations is presented in an intuitive format on a dashboard (106), highlighting actionable insights and recommendations, comprising, by way of example, personalised meal planning, identification of potential health risks, or guidance to third-party service providers such as dog walkers or boarding facilities on handling individual pets.

The system (100) further comprises a hardware integration module (103) configured to interface with one or more sensor-equipped devices associated with a pet to acquire physiological, behavioural, and/or environmental data associated with the pet. The sensor-equipped devices include wearable devices, smart collars, activity trackers, biometric monitoring devices, environmental sensors, and/or monitoring systems positioned in proximity to the pet. In an embodiment, the hardware integration module (103) enables synchronization of the said hardware devices with a cloud-based platform to facilitate transmission of sensor-driven and activity-related data to the central database (104), where the data is stored as structured interaction records. The data processing and insight generation module (105) retrieves the stored sensor-driven pet data from the central database (104) for performing inference generation, behavioural analysis, and recommendation operations. Further, the system (100) comprises a third-party integration module (107) including one or more application programming interfaces that enables communication between the system (100) and the external service providers. Insights generated by the data processing and insight generation module (105) are presented through a dashboard (106) implemented within mobile-based or web-based applications, to selectively share, in an authorized manner, with third-party service providers such as veterinarians, trainers, or other pet-related service entities through third party integration module (107).

The system's (100) application programming interfaces enable integration with external third-party services, including, by way of example and not limitation, pet insurance providers for personalized policy offerings, organic pet food providers for nutritional planning, pet boarding applications for sharing pet-specific requirements, pet supply vendors, and veterinary service providers. Such integrations facilitate coordinated interaction between pet owners and industry providers and are configured in accordance with the specific services selected or authorized by the pet owner.

Further, the data processing and insight generation module (105) is configured to detect and analyse patterns associated with individual pets, including, by way of example, walking routines, dietary habits, and observed behavioural tendencies, thereby enabling generation of actionable recommendations. The data processing and insight generation module (105) further enables timely access to pet-specific metadata and derived intelligence, which improves the quality and effectiveness of services provided by authorized third-party entities. The generated metadata and derived insights are organized and presented through dashboards (106) for consumption by pet owners and, where permitted, third-party service providers through the third party integration module (107).

The hardware integration module (103) enables continuous monitoring of the pets by facilitating acquisition of sensor-driven data and related observations. In one embodiment, a smart collar equipped with sensors such as a heart rate sensor, temperature sensor, accelerometer, gyroscope, global positioning system (GPS) sensor, and ambient light sensor are configured to monitor physiological parameters, activity levels, and movement patterns of the pet. Additionally, in another embodiment, a home monitoring robot may be configured to observe interactions, behaviours, and environmental conditions associated with a pet, thereby contributing to ongoing data collection for behavioural and wellness analysis of the pets.

Further, the dashboard (106) is configured to provide intuitive visualization of the generated insights of the pets for the pet owners, including but not limited to health trends, recommended actions, and projected indicators derived from pet-related intelligence. In an embodiment, the system (100) supports secure and authorized sharing of selected insights with third-party service providers to facilitate coordinated and collaborative pet care through the third party integration module (107).

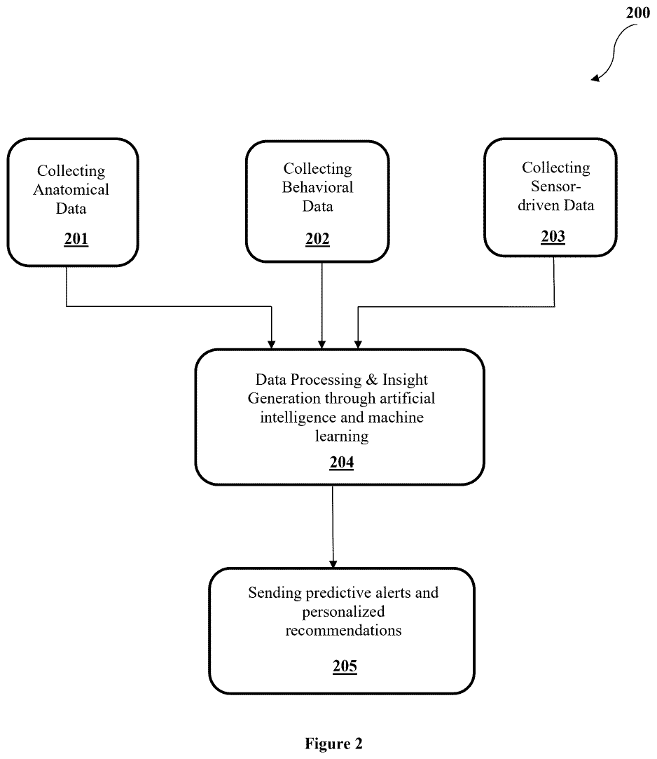

FIG. 2 illustrates a flowchart for a method (200) of personalised pet care recommendations in accordance with one or more embodiments of the present invention. In one embodiment, the method (200) begins with collecting pet-related data from multiple sources. At step (201), anatomical data associated with an individual pet is collected, comprising historical and species-related information such as breed characteristics, medical history, genetic predispositions, and past health records. At step (202), behavioural data is collected based on user-provided inputs, comprising observed behavioural patterns, feeding habits, activity levels, and owner-reported concerns, thereby reflecting the pet's lifestyle and environment. At step (203), sensor-driven data is collected through sensors, wearable devices, or monitoring systems, the sensor-driven data comprising physiological and activity-related parameters such as heart rate, body temperature, movement patterns, and dietary intake, captured on a continuous or near-continuous basis.

At step (204), the collected anatomical, behavioural, and sensor-driven data is processed using one or more data processing techniques to analyse correlations, identify patterns, detect anomalies, and assess potential health or behavioural risks. In one embodiment, the processing may employ artificial intelligence techniques, machine learning models, statistical analysis, or rule-based logic to generate inferred insights and predictions, thereby enabling dynamic adjustments to pet care routines, dietary planning, and health monitoring strategies.

At step (205), predictive alerts and personalised recommendations are generated and provided to pet owners. The predictive alerts may comprise reminders for vaccinations, dietary adjustments, behavioural training, routine check-ups, or other proactive care measures. The personalised recommendations are tailored to the specific needs of the individual pet and may further comprise service recommendations comprising, by way of example and not limitation, pet walking services, boarding services, veterinary services, grooming services, emergency services, nutritional services, and training services.

In one or more preferred embodiments, the method for personalised pet care recommendations comprises the steps of recording pet-related interaction events as immutable, time-stamped evidentiary records; generating versioned pet profile states by creating time-indexed updates without overwriting prior profile states; resolving conflicts between incoming attribute values derived from pet-related interaction events and corresponding existing attribute values stored in the current versioned pet profile state using weighted arbitration logic; deriving inferred pet attributes and behavioural insights of the pet through longitudinal analysis of correlated interaction events; applying confidence decay to inferred pet attributes in the absence of corroborating evidentiary records; invalidating the inferred pet attribute responsive to the associated confidence value falling below a predefined threshold; assembling contextual data from selected evidentiary records and inferred attributes; and, generating and storing the personalised pet care recommendations in a centralized data repository, and disseminating the personalised pet care recommendations through one or more permissioned logical projections.

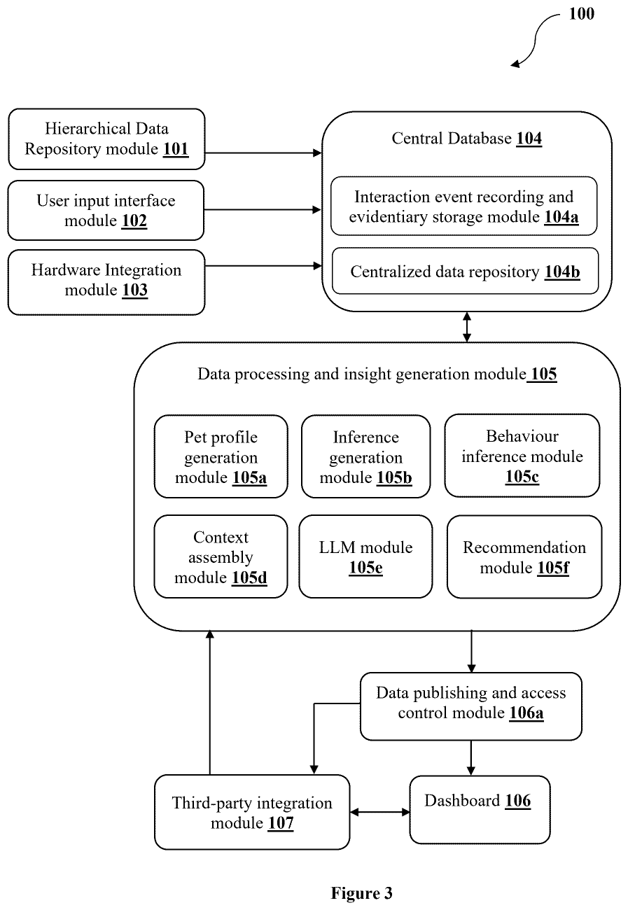

FIG. 3 illustrates a block diagram of an exemplary logical decomposition of a data processing and insight generation module of the system for personalised pet care recommendations depicted in FIG. 1, together with associated cooperation with a central database and a data publishing and access control module, in accordance with one or more embodiments of the invention. The illustrated logical decomposition is explanatory, non-limiting and represents one possible functional organization of the system (100) rather than a required physical implementation, deployment architecture, or execution environment.

In the exemplary illustrative embodiment, the system (100) comprises a central database (104) that aggregates pet-related data originating from a hierarchical data repository module (101), a user input interface module (102), and a hardware integration module (103). The central database (104) comprises an interaction event recording and evidentiary storage module (104a) configured to store raw data of pet-related interaction events as immutable, time-stamped evidentiary records, and a centralized data repository (104b) configured to store structured pet intelligence and associated confidence and metadata values derived from the recorded interaction events associated with individual pets.

The logical separation between the raw evidentiary records and derived structured pet intelligence preserves the evidentiary integrity of the recorded pet-related interaction events by preventing modification, deletion, or retrospective alteration of the interaction events once recorded, while further enabling iterative refinement, confidence decay, and longitudinal updating of the derived pet intelligence over time without overwriting.

The hierarchical data repository module (101), the interaction event recording and evidentiary storage module (104a) and the centralized data repository (104b), collectively define the plurality of data repositories of the system (100), that store pet-related data including but not limited to population-level structured reference data for the pets, derived structured pet intelligence, raw immutable evidentiary records of the interaction events, and associated pet-related metadata.

The data processing and insight generation module (105) is configured to retrieve pet-related data from the central database (104), population level structured reference data for the pet from the hierarchical data repository module (101) and to derive structured pet intelligence and personalized pet care recommendations which is stored in the centralized data repository (104b) without modifying the evidentiary records of the interaction events.

In an embodiment, the structured pet intelligence stored in the centralized data repository (104b) comprises versioned pet profile states that includes structure attributes and inferred pet attributes along with confidence scores, temporal validity parameters, and associated metadata derived from the interaction event records.

The interaction event recording and evidentiary storage module (104a) stores pet-related interaction events as immutable, time-stamped evidentiary records. The stored interaction event records represent raw evidentiary data associated with the pet and are preserved without modification to maintain evidentiary integrity.

In one embodiment, the data processing and insight generation module (105) comprises a pet profile generation module (105a) configured to generate time-indexed, versioned pet profile states and store the generated versioned pet profile state in the centralized data repository (104b). The pet profile generation module (105a) receives interaction event records from the interaction event recording and evidentiary storage module (104a) and normalizes the incoming pet-related data into structured attribute-value representations of the pet profile. Conflicts between newly received attribute values and the existing attribute value residing in the existing pet profile states is resolved using weighted arbitration logic that considers source reliability, temporal recency and confidence thresholds. Each versioned pet profile states are preserved for longitudinal tracking of the inferred attribute evolution of the pet profile wherein the attributes includes health conditions, behavioural tendencies, dietary sensitivities and associated confidence variations for each pet.

The data processing and insight generation module (105) classifies incoming pet-related attributes into stable attributes and mutable attributes based on observed temporal variability.

The data processing and insight generation module (105) further comprises an inference generation module (105b) configured to derive inferred pet attributes wherein the inferred pet attributes comprises different attribute classes such as health, behaviour, diet, service suitability which are governed by distinct logic. The interaction event records are processed in conjunction with current pet profile states and population-level priors retrieved from the hierarchical data repository module (101). Each inferred pet attribute is associated with a confidence value and a temporal validity parameter and is stored in the centralized data repository (104b).

In a preferred embodiment, the data processing and insight generation module (105) implements inference generation using a deterministic, staged inference pipeline configured to derive pet-related attributes from validated interaction events and structured pet profile state. The data processing and insight generation module (105) further triggers an anomaly alert on exceeding a predefined threshold of a variance between an inferred attribute and one or more historical evidentiary records related to the pet

In a preferred embodiment, the inference generation module (105b) first executes a rule-based gating stage configured to evaluate interaction events and pet profile attributes against a predefined set of high-precision constraints. The rule-based gating stage enforces deterministic conditions including, without limitation, safety exclusions, medical restrictions, dietary prohibitions, and logically incompatible attribute combinations. When a rule condition is satisfied, the rule-based gating stage may assign a definitive inference outcome or restrict downstream inference generation for the affected attribute.

Following rule-based gating, the system executes a statistical prior evaluation stage configured to compute baseline likelihoods for candidate attributes using population-level distributions retrieved from the hierarchical data repository module (101). The statistical prior evaluation stage applies cohort-level probabilities derived from aggregated pet profiles sharing similar attributes including species, breed, age range, sex, and generalized behavioural characteristics. In cold-start conditions or when interaction evidence is sparse, the statistical prior evaluation stage establishes an initial probabilistic baseline for inference generation.

The inference generation module (105b) further executes a machine learning inference stage, that serves as the primary inference mechanism in the preferred embodiment. The machine learning inference stage evaluates temporally ordered interaction events and derived feature representations to produce a predicted attribute value and an associated confidence score. The machine learning model is trained on historical interaction sequences and verified outcome events and is configured to capture non-linear relationships across the behavioural, health-related, and contextual data.

Subsequently, the inference generation module (105b) executes a large language model-assisted reasoning stage configured to process a structured summary of interaction events, pet profile attributes, statistical priors, and machine learning outputs. The large language model-assisted reasoning stage is constrained to operate solely on the said structured summary and is configured to generate candidate interpretations, consistency checks, or explanatory annotations. The large language model-assisted reasoning stage is explicitly prevented from directly modifying pet profile state, interaction event records, or inference outputs.

Outputs from the machine learning inference stage and the large language model-assisted reasoning stage are provided to a deterministic arbitration stage, which reconciles candidate inference outputs using predefined weighting rules. In the preferred embodiment, the weighting rules prioritize machine learning outputs for probabilistic attribute estimation while permitting rule-based outputs to override conflicting inferences when safety or exclusion conditions are detected. The deterministic arbitration stage produces a final inferred attribute associated with a confidence value, temporal validity window, inference source identifiers, and explicit references to supporting interaction events.

The final inferred attribute is stored as part of the pet's structured intelligence state and is subject to confidence decay, such that the confidence value is reduced over time in the absence of corroborating interaction evidence and invalidated when the confidence value falls below a defined threshold.

The data processing and insight generation module (105) further comprises a behavioural inference module (105c) configured to analyse temporally ordered interaction event records to generate behavioural insights of the pet. The behavioural inference module (105c) identifies correlations, trends, or deviations indicative of evolving behavioural or health-related patterns of the pets. The generated behavioural insights of the pets along with confidence trajectories and evidentiary references are stored as part of the structured pet intelligence in the centralized data repository (104b).

In an embodiment, the behavioural inference module (105c) segments ordered interaction events into temporal windows and applies correlation and trend-detection logic to generate hypotheses representing behavioural states corresponding to the pet, such as anxiety likelihood, training progression, or health trend deviations. Further, the behavioural hypotheses are dynamically updated, validated, or invalidated as additional interaction evidence is observed.

The data processing and insight generation module (105) further comprises a context assembly module (105d) configured to selectively retrieve inferred pet attributes, behavioural insights of the pet, relevant interaction event records, and user interaction preferences to assemble a structured contextual representation for recommendation generation. The structured contextual representation comprises a filtered and validated subset of structured pet intelligence assembled for recommendation generation/downstream reasoning operations.

In an embodiment, the context assembly module (105d) performs intent-driven selection of structured pet intelligence by identifying a user requested task or trigger condition and retrieving only relevant inferred attributes, behavioural insights, and supporting interaction events required for downstream processing. Raw conversational transcripts are excluded from the assembled contextual data. By limiting the reasoning input to validated structured pet intelligence, the system (100) reduces computational overhead and mitigates generation of unsupported or hallucinated outputs.

During operation, the conversational interactions between a user and the system (100) through the user input interface module (101) are treated as ephemeral input channels. Conversational transcripts are not preserved as persistent system memory. Instead, validated structured data extracted from such conversations, including attribute updates, confirmations, corrections, or reported events, are normalized into ontology-aligned interaction events and recorded as immutable evidentiary records within the interaction event recording and evidentiary storage module (104a).

The data processing and insight generation module (105) further comprises a Large Language Model (LLM) module (105e) configured to operate as a constrained reasoning component on the assembled contextual data. The LLM module (105e) is restricted from directly modifying interaction event records or versioned pet profile states.

The data processing and insight generation module (105) further comprises a recommendation generation module (105f) configured to generate personalized pet care recommendations based on the assembled contextual data, inferred pet attributes, and behavioural insights of the pet.

The personalized pet care recommendations comprise dietary guidance, healthcare advisories, behavioural interventions, alerts, and service recommendations tailored to the pet profile.

The generated personalized pet care recommendations may be stored in the centralized data repository (104b) or generated dynamically in response to an authorized request and are displayed through the dashboard (106) or the third party integration module (107).

The system (100) further comprises a data publishing and access control module (106a) to safeguard the pet profile generation module (105a) from unauthorised access. permissioned logical projections are segmented into at least a consumer-facing projection for a dashboard interface and a professional-facing projection for a third-party integration interface. In an embodiment, during operation, only a contextualized and authorized projection of structured pet intelligence is transmitted to the dashboard (106) functions as a consumer-facing interface for consumer visualisation or to the third-party integration modules (107) for professional business-to-business or business-to-nonprofit utilization. By way of example, the consumer-facing interface may receive a summarized recommendation with explanatory context, while a professional interface receives an aggregated behavioural trend view, both derived from the same structured pet intelligence wherein the access to the structured pet intelligence is provided through logical projections governed by access policies and domain segmentation rules, rather than through physical data duplication.

The data publishing and access control module (106a) is configured to control dissemination of the structured pet intelligence and the personalized pet care recommendations generated by the data processing and insight generation module (105).

The data publishing and access control module (106a) generates permissioned logical projections of the structured pet intelligence, wherein each logical projection represents a domain-specific view derived from a common underlying data source without duplicating the stored data. For consumer-facing (B2C) access, the data publishing and access control module (106a) exposes authorized structured pet intelligence and personalized pet care recommendations through the dashboard (106). For business-facing (B2B) and nonprofit-facing (B2N) access, the data publishing and access control module (106a) utilizes the third-party integration module (107) to enable authorized access to selected portions of the structured pet intelligence and personalized pet care recommendations.

The data publishing and access control module (106a) controls dissemination of structured pet intelligence generated by the data processing and insight generation module (105). The structured pet intelligence comprises versioned pet profile states, inferred pet attributes, behavioural insights of the pet, aggregated intelligence summaries, and associated metadata stored within the one or more data repositories.

The permissioned logical projections include consumer-facing projection, business-facing projection, and nonprofit-facing projection corresponding to business-to-consumer (B2C), business-to-business (B2B), and business-to-nonprofit (B2N) contexts, respectively.

In an embodiment, the consumer-facing projection comprises one or more behavioural narratives or health alerts of the pet, the professional-facing projection comprises risk markers or aggregated behavioural indicators and a non-profit-facing projection comprises anonymized or aggregated pet intelligence.

The system (100) is implemented using one or more processors operatively coupled to one or more memory units storing executable instructions. The executable instructions, when executed by the one or more processors, cause the one or more processors to perform the recording of interaction events, generation and maintenance of versioned pet profile states, resolution of conflicts using weighted arbitration logic, derivation of inferred pet attributes and behavioural insights, application of confidence decay, assembly of structured contextual representations, and generation of permissioned logical projections. The one or more memory units comprise non-transitory computer-readable storage media.

In one exemplary implementation, the system (100) for personalised pet care recommendations is implemented using a modular and distributed computing architecture, wherein the user input interface module (102), hardware integration module (103), data processing and insight generation module (105), including the LLM module (105e) functioning as a reasoning component are deployed across one or more computing environments. In such embodiments, external agents, sensor-based data sources, and third-party services provide pet-related data inputs to a centralized data processing layer that cooperates with the data processing and insight generation module (105) to derive structured pet intelligence and generate personalized recommendations.

In the exemplary implementation, the dashboard (106) acts as user-facing interface that presents pet profile information, recommendations, alerts, incentives, or service offers, while backend components manage interaction event ingestion, evidentiary storage, inference generation, behavioural analysis, and contextual reasoning. The invention further supports integration with pet shelters, hardware devices, social platforms, and third-party service providers through the third-party integration modules (107).

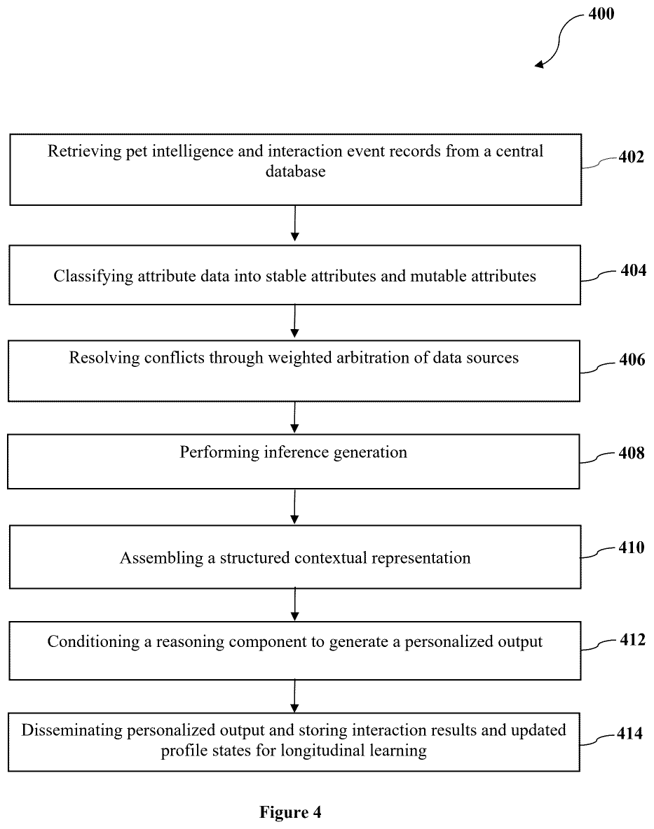

FIG. 4 illustrates a method of an exemplary operational workflow for data processing and insight generation performed by the system (100) for personalised pet care recommendations. The method (400) comprises a sequence of processing steps executed by the data processing and insight generation module (105) in cooperation with the central database (104). The illustrated sequence is exemplary and individual steps may be combined, reordered, or executed iteratively without departing from the scope of the invention.

At step (402), pet intelligence and interaction event records are retrieved from the central database (104). The retrieved data comprises previously stored versioned pet profile states, inferred pet attributes, behavioural insights, and immutable, time-stamped interaction event records associated with the pet.

At step (404), incoming pet-related attributes derived from newly recorded interaction events are classified into stable attributes and mutable attributes based on observed temporal variability.

At step 406, conflicts between newly ingested attribute data derived from interaction events and existing attribute within recent pet profile states are resolved through application of weighted arbitration logic of the data sources. In an embodiment, multiple data inputs associated with a given attribute are evaluated relative to one another based on criteria such as source reliability, temporal recency, historical consistency, contextual relevance, and/or confidence thresholds. Further, updated attribute determinations are generated while preserving prior profile states and underlying evidentiary records, thereby maintaining evidentiary continuity and supporting longitudinal analysis. The source reliability weighting is determined based on a classification of the data source as sensor-derived, user-entered, or third-party sourced.

At step (408), inference generation is performed based on the validated attribute data produced at earlier steps and is executed using a staged inference pipeline comprising rule-based gating, statistical prior evaluation using population-level priors retrieved from the hierarchical data repository module (101), machine learning inference on temporally ordered interaction event records, and deterministic arbitration of the candidate inference outputs. The inference generation produces the inferred pet attributes associated with confidence values and temporal validity parameters.

At step (410), relevant contextual data is assembled by selectively aggregating pet profile attributes, inferred attributes, behavioural indicators, and interaction history. The selection of contextual data elements is guided by detected intent or triggering conditions, thereby constraining subsequent processing to relevant and validated data subsets.

At step (412), a reasoning component is conditioned using the assembled contextual data to generate a personalized output. The personalized output may include recommendations, alerts, guidance, or explanatory information tailored to the current pet profile state. The conditioning ensures that generated outputs remain grounded in validated data and inferred intelligence

At step (414), the generated outputs are disseminated through the dashboard (106) or the third-party integration module (107), and subsequent interaction outcomes are recorded as immutable interaction event records. Updated inferred pet attributes and versioned pet profile states are stored in the centralized data repository (104b). The inferred pet attributes are subject to confidence decay in the absence of corroborating interaction evidence and are invalidated when the associated confidence value falls below a predefined threshold.

The modular and scalable system architecture accommodates a wide range of pets such as dogs, cats, guinea pigs, reptiles etc. and extends functionality to niche pets through modular updates. The system and method are structured to prioritize efficiency, scalability, and user convenience. In an embodiment, the cloud-based infrastructure ensures uninterrupted data flow between the components, while the modular design allows for phased upgrades.

### Example 1: Evidentiary Conflict Resolution and Longitudinal Pet Profile State Update

In one exemplary embodiment, a pet owner provides daily walking duration entries for his pet, a dog through the user input interface module (102), while a wearable device associated with the dog transmits sensor-driven activity measurements through the hardware integration module (103). Both user-entered and sensor-derived activity data are recorded as separate immutable, time-stamped interaction event records within the interaction event recording and evidentiary storage module (104a). Each interaction event is stored together with metadata such as the source of the event, the method of capture, and the time of occurrence.

Over a few days, newly recorded sensor-derived interaction events indicate a gradual reduction in total daily step count and active movement duration relative to historical sensor records previously associated with the dog. During the same period, the owner-submitted interaction events continue to indicate unchanged walking routines. These interaction events are retrieved by the data processing and insight generation module (105) together with an existing pet profile state stored in the centralized data repository (104b), the existing pet profile state indicating a normal activity level established from earlier corroborated data.

Upon detecting mutually inconsistent activity indicators for the newly ingested interaction events, the data processing and insight generation module (105) initiates a conflict-resolution process. In this embodiment, the data processing and insight generation module (105) evaluates each interaction event individually by applying predefined reliability evaluation criteria stored within the system (100).

Based on the reliability evaluation criteria associated with the exemplary embodiment, interaction events originating from the hardware integration module (103) are assigned a higher reliability weight than interaction events originating from the user input interface module (102) when the interaction events correspond to objectively measurable parameters captured at defined sampling intervals. Further, user-entered interaction events are assigned a lower reliability weight in this embodiment when the interaction events represent manually estimated values lacking temporal granularity. In addition, the data processing and insight generation module (105) applies a temporal weighting factor that increases the influence of more recently recorded interaction events relative to older events.

The data processing and insight generation module (105) further applies a confidence decay function to historical activity indicators stored in the pet profile state that are not corroborated by recent interaction events. As a result, the confidence associated with older activity indicators is progressively reduced over time in the absence of supporting sensor-derived evidence.

Using the assigned reliability weights, temporal weighting factors, and confidence decay values, the data processing and insight generation module (105) computes comparative confidence scores for the competing activity indicators. In this embodiment, the aggregated confidence score associated with the recent sensor-derived interaction events exceeds the aggregated confidence score associated with the owner-submitted interaction events. The data processing and insight generation module (105) therefore determines that the sensor-derived interaction events more accurately represent the current activity state of the dog.

Further, instead of overwriting the existing pet profile state, the data processing and insight generation module (105) generates a new versioned pet profile state reflecting a reduced activity level. The new versioned state is stored in the centralized data repository (104b) that associate each inferred pet attribute with a confidence value and a temporal validity parameter together with references to the supporting interaction events. The prior pet profile state is retained as a historical record, thereby enabling longitudinal tracking of activity changes over time.

Further, relevant contextual data is assembled from the updated pet profile status assembled from the updated pet profile state and the supporting interaction events. Upon authorization by the data publishing and access control module (106a), a personalized recommendation indicating a sustained reduction in activity is transmitted to the dashboard (106) for presentation to the pet owner. The underlying evidentiary records and historical pet profile states remain protected within the centralized data repository (104b) and are not directly exposed to the dashboard.

### Example 2: Authorized Domain-Specific Projection of Structured Pet Intelligence

In another exemplary embodiment, structured pet intelligence derived from interaction events and pet profile states is accessed by an external entity through a third-party integration module (107). Prior to granting access, the data publishing and access control module (106a) evaluates authorization credentials associated with the requesting entity to determine a permissible scope of data exposure based on the entity's domain classification (e.g., B2B or B2N).

Upon successful authorization, the data publishing and access control module (106a) retrieves derived pet intelligence from the centralized data repository (104b). The retrieved intelligence comprises inferred behavioural indicators, longitudinal trend metadata, and associated confidence values generated by the data processing and insight generation module (105). The raw interaction events stored in the interaction event recording and evidentiary storage module (104a) remain inaccessible to the external entity, maintaining a “Zero Trust” security boundary between the raw evidence and the outbound projection.

In this embodiment, the data publishing and access control module (106a) generates a permissioned logical projection of the structured pet intelligence tailored to the specific domain of the requester or the user. For a professional service provider (B2B), such as a veterinarian or insurance underwriter, the logical projection comprises summarized activity deviations and confidence-weighted risk markers suitable for expert assessment and policy adjustment. For a non-profit entity (B2N), such as a shelter or rescue organization, the logical projection comprises anonymized and aggregated behavioural indicators and population-level analytics, strictly excluding pet-specific or owner-specific identifiers.

The permissioned logical projection is transmitted to the authorized endpoint through the dashboard (106) for consumer-facing (B2C) applications, or through the third-party integration module (107) for business (B2B) and non-profit (B2N) applications. The underlying centralized data repository (104b) remains protected as the single source of truth, thereby enabling controlled multi-domain dissemination of pet intelligence without ever exposing raw evidentiary records or sensitive historical profile states to unauthorized parties.

### Example 3: Cold-Start Pet Profile Initialization Using Hierarchical Reference Data

In another exemplary embodiment, the system (100) initializes a pet profile for a newly registered pet for which limited or no historical interaction events are available. The pet owner registers the pet through the user input interface module (102) and provides baseline information comprising species, breed, age range, sex, and general lifestyle indicators. In the embodiment, subsequent information requests presented to the user are dynamically determined based on the detected profile incompleteness and confidence values associated with inferred pet attributes. Questions corresponding to attributes having sufficient confidence or completeness is suppressed, while questions associated with low-confidence or missing attributes is prioritized, reordered, or reintroduced over time through a continuous learning loop.

Upon registration, the data processing and insight generation module (105) determines that insufficient pet-specific interaction events are present within the interaction event recording and evidentiary storage module (104a) to establish a reliable individualized pet profile state. In response, the data processing and insight generation module (105) retrieves hierarchical reference data from the hierarchical data repository module (101) corresponding to the declared species, breed, and age range of the pet.

The hierarchical reference data comprises population-level behavioural patterns, activity baselines, dietary norms, and health-related statistical indicators derived from aggregated and anonymized data associated with similar pets. Using the retrieved hierarchical reference data, the data processing and insight generation module (105) generates an initial pet profile state representing a probabilistic baseline rather than a confirmed individualized state.

The initial pet profile state is stored in the centralized data repository (104b) together with an associated confidence value and a temporal validity window indicating that the profile state is provisional and subject to refinement. As the temporal validity of the population-level priors expires, or as subsequent interaction events are recorded through the interaction event recording and evidentiary storage module (104a), the data processing and insight generation module (105) incrementally updates the pet profile state by reconciling the incoming pet-specific interaction events with the hierarchical reference data through a weighted arbitration logic.

Over time, as corroborating pet-specific interaction events accumulate, the influence of the hierarchical reference data is progressively reduced through the application of the confidence decay function. The pet profile state transitions from a population-derived baseline to an individualized profile reflecting the observed behaviour and activity patterns of the specific pet. The refined pet profile state is retained in the centralized data repository (104b) together with references to the supporting interaction events, thereby enabling longitudinal continuity from initial registration through ongoing personalized pet care.

The system and method offer multiple advantages by providing improved data integrity, longitudinal analysis, and governed dissemination of pet intelligence. In one aspect, the invention enhances data reliability through multi-source weighted arbitration. Pet-related data originating from heterogeneous sources is evaluated using weighted arbitration logic that considers factors comprising source reliability and temporal recency, thereby reducing inconsistencies arising from conflicting inputs and improving the accuracy of maintained pet profile states.

Further, the system and method enable longitudinal state tracking without loss of historical information. By maintaining immutable interaction event records and versioned pet profile states, the system preserves historical pet intelligence rather than overwriting prior data. This allows longitudinal analysis of pet behaviour and health trends over extended periods, such as gradual changes in activity patterns or behavioural indicators, which may not be detectable in systems that maintain only a current-state representation.

In another aspect, the system and method incorporate confidence decay and invalidation mechanisms to mitigate reliance on outdated information. Inferred pet attributes are associated with confidence values that decay over time in the absence of corroborating interaction events, enabling automatic invalidation of stale intelligence and supporting adaptive refinement of pet profiles as new data becomes available.

Further, the system and method support secure, multi-tenant dissemination of pet intelligence through permissioned logical projections. A data publishing and access control mechanism allows different stakeholders to access contextualized and authorized projections of pet intelligence while preserving a protected single source of truth. This architecture enables controlled sharing across consumer-facing, business-facing, and non-profit-facing domains without exposing underlying evidentiary records or compromising data privacy.

The system and method improve computational efficiency during pet intelligence generation. By assembling relevant contextual data and pre-selecting validated evidentiary records prior to reasoning, the system reduces data processing overhead. This results in more efficient use of computational resources and improved responsiveness compared to approaches that process unfiltered or unstructured pet data.

TABLE
Reference numbers

| Components | Reference Numbers |
|---|---|
| System | 100 |
| Hierarchical Data Repository module | 101 |
| User input Interface module | 102 |
| Hardware Integration module | 103 |
| Central Database | 104 |
| Interaction event recording and | 104a |
| evidentiary storage module | |
| Centralized data repository | 104b |
| Data processing and insight | 105 |
| generation module | |
| Pet profile generation module | 105a |
| Inference generation module | 105b |
| Behaviour inference module | 105c |
| Context assembly module | 105d |
| LLM module | 105e |
| Recommendation module | 105f |
| Data publishing and access | 106a |
| control module | |
| Dashboard | 106 |
| Third-Party Integration Modules | 107 |

We claim:

1. A system for personalized pet care recommendations, the system comprising:
one or more processors operatively coupled to one or more memory units storing a plurality of executable instructions;
a plurality of data repositories configured to store pet-related data associated with a plurality of pets;
a hardware integration module configured to interface with one or more sensor-equipped devices associated with the pets to acquire sensor-driven pet data;
a user input interface module configured to receive pet-related data, captured from the conversational interactions of the user with the system;
a data processing and insight generation module connected to the data repositories and configured to process pet-related data to generate structured pet intelligence and personalized pet care recommendations; and
a data publishing and access control module connected to one or more external interfaces and configured to disseminate the structured pet intelligence and the personalized pet care recommendations;
wherein the executable instructions, when executed by the one or more processors, cause the one or more processors to:
store pet-related interaction events as immutable, time-stamped evidentiary records;
generate and maintain versioned pet profile states;
resolve one or more conflicts between one or more incoming attribute values derived from pet-related interaction events and corresponding existing attribute values stored in a current versioned pet profile state using weighted arbitration logic;
derive inferred pet attributes and behavioural insights of the pet;
associate each inferred pet attribute with a confidence value and a temporal validity parameter;
calculate and apply confidence decay to one or more inferred pet attributes and invalidate an inferred pet attribute responsive to an associated confidence value falling below a predefined threshold;
generate structured pet intelligence and personalized pet care recommendations; and
disseminate the structured pet intelligence and the personalized pet care recommendations to one or more external interfaces through one or more permissioned logical projections.

2. The system of claim 1, wherein the plurality of data repositories comprise:
a hierarchical data repository module to store population-level structured reference data;
an interaction event recording and evidentiary storage module configured to store immutable, time-stamped interaction event records representing raw evidentiary data associated with a pet; and
a centralized data repository configured to store a plurality of structured pet profile states, inferred pet attributes, behavioural insights of the pet, and associated confidence and metadata values derived from the recorded interaction events associated with the individual pet.

3. The system of claim 1, wherein the data processing and insight generation module is configured to classify incoming pet-related attributes into stable attributes and mutable attributes based on observed temporal variability.

4. The system of claim 1, wherein the hierarchical data repository module configured to store structured categorical and sub-categorical reference data associated with animal types, species, breeds, and generalized behavioural classifications used for inference generation and statistical prior evaluation of a pet.

5. The system of claim 1, wherein the data processing and insight generation module is configured to provide assembled contextual data to a reasoning component, and wherein the reasoning component is restricted from directly modifying the evidentiary records or the versioned pet profile state stored in the data repositories.

6. The system of claim 1, wherein the reasoning component comprises one or more language models configured to generate interpretive narratives or explanations grounded in the assembled contextual data derived from the structured pet attributes and interaction event records.

7. The system of claim 1, wherein the system comprises a hierarchical data repository module configured to provide population-level priors based on species, breed, and/or age characteristics of plurality of pets to initialize or bias the inference generation.

8. The system of claim 1, wherein the permissioned logical projections are segmented into at least:
a consumer-facing projection for a dashboard interface; and
a professional-facing projection and a non-profit-facing projection for a third-party integration interface.

9. The system of claim 8, wherein:
the consumer-facing projection comprises one or more behavioural narratives or health alerts of the pet;
the professional-facing projection comprises risk markers or aggregated behavioural indicators; and
a non-profit-facing projection comprises anonymized or aggregated pet intelligence.

10. The system of claim 1, wherein the data processing and insight generation module is configured to trigger an anomaly alert on exceeding a predefined threshold of a variance between an inferred attribute and one or more historical evidentiary records related to a pet.

11. The system of claim 1, wherein resolving conflicts using weighted arbitration logic comprises evaluating incoming pet-related data using a plurality of weighting factors including at least source reliability, temporal recency, and confidence thresholds.

12. The system of claim 11, wherein the source reliability weighting is a function of a plurality of data sources classified as sensor-derived, user-entered, or third-party sourced.

13. The system of claim 1, wherein the confidence decay applied to an inferred pet attribute is a function of elapsed time since capture of a most recent corroborating interaction event.

14. The system of claim 1, wherein the data processing and insight generation module performs inference generation using a staged inference pipeline comprising:
a rule-based gating stage;
a statistical prior evaluation stage using population-level priors;
a machine learning inference stage operating on temporally ordered interaction events; and
a deterministic arbitration stage configured to reconcile candidate inference outputs.

15. The system of claim 1, wherein the conversational interactions received through the user input interface module are excluded from storage, and wherein the pet-related interaction events derived therefrom are stored as immutable, time-stamped evidentiary records.

16. A computer-implemented method for personalised pet care recommendations, the method comprising the steps of:
recording pet-related interaction events as immutable, time-stamped evidentiary records;
generating versioned pet profile states by creating time-indexed updates without overwriting prior profile states;
resolving conflicts between incoming attribute values derived from pet-related interaction events and corresponding existing attribute values stored in a current versioned pet profile state using weighted arbitration logic based on source reliability and temporal recency;
deriving inferred pet attributes and behavioural insights through longitudinal analysis of correlated interaction events;
applying confidence decay to inferred pet attributes in the absence of corroborating evidentiary records;
invalidating an inferred pet attribute responsive to the associated confidence value falling below a predefined threshold;
assembling contextual data from selected evidentiary records and inferred attributes; and
generating and storing the personalised pet care recommendations in a centralized data repository, and disseminating the personalised pet care recommendations through one or more permissioned logical projections.

17. The method of claim 15, wherein generating the versioned pet profile states comprises classifying incoming pet-related attributes into stable attributes and mutable attributes based on observed temporal variability.
